(19) United States
(12) Patent Application Publication
(10) Pub. No.: US 2005/0071845 A1
(43) Pub. Date: Mar. 31, 2005

(54) Terminal equipment, an accessory and a method of communication between terminal equipment and an accessory

(76) Inventors: Janne Kallio, Pattijoki (FI); Oskari Ketola, Oulu (FI)

Correspondence Address: Crawford Maunu PLLC, Suite 390, 1270 Northland Drive, St. Paul, MN, 55120, US

(21) Appl. No.: 10/673,796

(22) Filed: Sep. 29, 2003

(51) Int. Cl. G06F 3/00

(52) U.S. Cl. 719/310

(57) ABSTRACT

Terminal equipment and a method of communication between terminal equipment and an accessory connected to the terminal equipment. The terminal equipment provides an application interface for services offered by the terminal. An accessory software application is executed in the accessory, and a proxy application is executed in the terminal equipment. The proxy application provides the accessory software application with the services offered by the application interface.

### FIELD

The invention relates to communication between terminal equipment and an accessory connected to the terminal equipment.

### BACKGROUND

Terminal equipment was originally used only for speech transmission. Such terminals were originally standalone devices without any accessories. For some time the usage of terminal equipment has widened also to other areas. Also the usability and user friendliness has grown important in terminal design. One way to increase the usability of terminal equipment is to use auxiliary accessories, which are connected to terminal equipment. Such accessories, to name a few, include hands-free equipment, computer connection and external handset, for example.

Advanced accessories may include a processor and/or software and they may require software support from the terminal equipment. This presupposes a data connection between the accessory and the terminal equipment.

There are several known methods to connect accessories to terminal equipment. The connection may be a physical connection or it may be realized with a cordless connection. Known methods comprise RS232, USB (Universal Serial Bus), Bluetooth, Infrared, or different proprietary buses. Terminal equipment may support many different connection types.

In prior art solutions the software support has been hard coded in the terminal equipment in the manufacturing phase. The types of accessories supported by the terminal equipment have thus been limited and not adjustable by the user.

With the arrival of sophisticated terminal equipment with processors capable of executing different applications it has been possible for users to load supporting applications for their accessories into the terminal equipment. Thus, the number of accessories the terminal equipment can support has increased. However, this solution is also cumbersome in many ways.

One software platform used in modern terminal equipment is java. Java applications are used in terminal equipment for various purposes. For example, they may provide an interface to input/output functions or communication features of the terminal equipment. These interfaces may be called application program interfaces (API). Different kinds of software may utilize these functionalities of the terminal equipment by using these interfaces. Accessories connected to the terminal equipment may utilize these interfaces by way of associated accessory software uploaded into the terminal equipment. A drawback of this solution is that application software must be designed separately for each terminal equipment type. Furthermore, the loading of accessory software may be time-consuming especially if the software is large, as may be the case with sophisticated accessories.

### BRIEF DESCRIPTIONS OF THE INVENTION

An object of the invention is to provide an improved solution to the communication between an accessory and terminal equipment. An object of the invention is to establish a flexible and versatile solution for accessory support in terminal equipment. According to an embodiment of the invention, there is provided a terminal equipment comprising: a connection interface enabling an accessory to be connected to the terminal equipment, an application interface to services offered by the terminal, and a software platform configured to execute a proxy application providing services offered by the application interface for an accessory software application executed in an accessory connected to the terminal equipment.

According to another embodiment of the invention, there is provided a method of communication between terminal equipment and an accessory connected to the terminal equipment, the method comprising providing in the terminal equipment an application interface for services offered by the terminal, executing an accessory software application in the accessory, executing a proxy application in the terminal equipment, the proxy application providing the accessory software application with the services offered by the application interface.

According to another embodiment of the invention, there is provided an accessory for terminal equipment, comprising means for connecting the accessory to the terminal equipment, means for executing an accessory software application, configured to communicate with the terminal equipment via a proxy application executed in the terminal equipment and to utilize services offered by the terminal equipment via the proxy application.

In this application the term accessory refers to a device, which may be either a fixed part of terminal equipment, such as a cover, or a separate device that can be connected to terminal equipment via a wireless or a wireline connection. The accessory may be an independently functioning external device such as a personal computer, terminal equipment or a household device, or a device designed to be operated only with terminal equipment. The accessory of the preferred embodiments comprises means for executing accessory software and means for communicating with the terminal equipment it is connected with.

The solution of the invention provides several advantages. The solution enables easy accessory implementation, without a need for the terminal equipment to support each accessory individually. This enables easy support for a wide variety of intelligent accessories for equipment with suitable software platform, such as java.

Terminal equipment of different types may comprise application program interfaces with support for different functions. For example, high end products may have more functions available than low end equipment. However, the same accessory can be used with mobiles of different categories without a need for modification of required software.

The user interface of the accessory may be provided by an application interface of the terminal equipment, or the user interface of the terminal equipment may be provided by the accessory.

Thus, terminal equipment does not have to support each accessory individually. Terminal equipment according to preferred embodiments comprises a software platform providing support for API. In the case of java, a java virtual machine is required, and java APIs are required for java usage and at least one API is required for bearer that is used for communication between the terminal equipment and accessory. The communication medium may be realized in different ways. One solution is to use wireless Bluetooth, and in some embodiments a wireline or infrared transmission may be used. The software platform may also be implemented in other ways, such as a Symbian operating system, in which case the proxy application may be realized as a Symbian application, for example.

With the presented solution a high variety of accessories can be used with many different terminal equipment models without a need for each model to support the special functions of each accessory. There is thus no need to hardcode the support of an accessory into the terminal equipment, for example.

With the presented solution accessories may easily use the services and properties the terminal equipment offers in the API. When an accessory is connected to the terminal equipment, it is automatically detected. The terminal equipment may obtain the capabilities of the software of the accessory. When the terminal equipment finds a proxy application in the accessory the application is automatically loaded into the terminal equipment. In an embodiment the terminal equipment may check if the proxy application is already in the terminal equipment memory, and if it is, the terminal equipment may check whether the version in the memory is older than the version in the accessory, and in which case the newer version is loaded into the terminal equipment.

The proxy application is started in the terminal equipment. The proxy application sets up a connection between the terminal equipment and the accessory software applications in the accessory. The proxy application detects the application programming interface of the terminal equipment, checks the version and the functions supported by the API, and transmits information regarding these properties to the accessory. The proxy application enables the accessory software to utilize the services the terminal equipment offers via the API functions.

### LIST OF DRAWINGS

In the following, the invention will be described in greater detail with reference to the preferred embodiments and the accompanying drawings, in which

FIGS. 1A to 1C illustrate an embodiment of the invention,

FIG. 2 illustrates an embodiment of the invention with a flowchart, and

FIGS. 3A to 3C illustrate embodiments of the invention.

### DESCRIPTION OF EMBODIMENTS

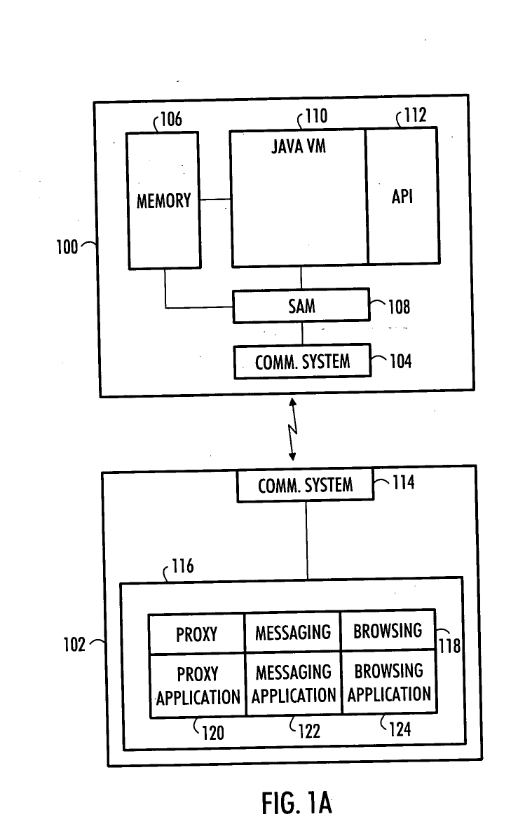

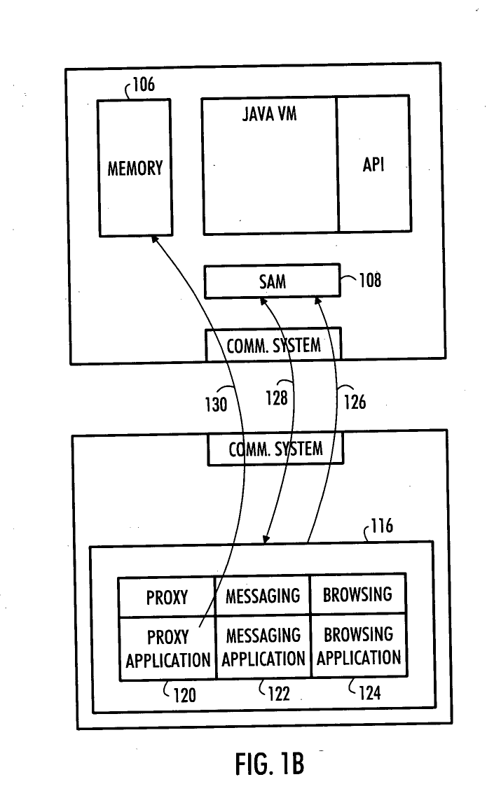

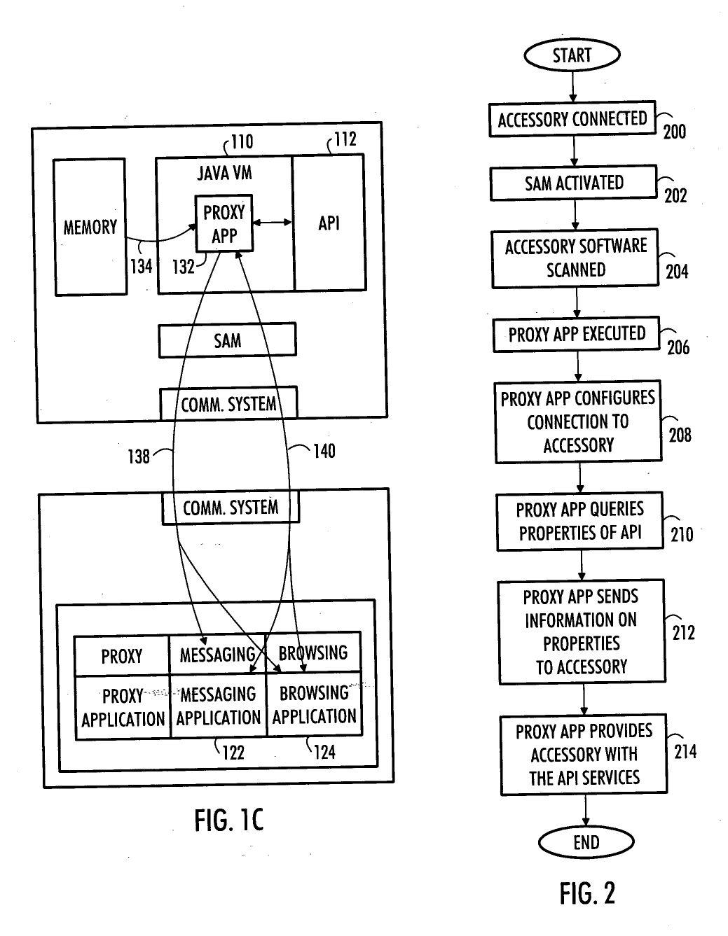

With reference to FIGS. 1A to 1C and 2, examine an embodiment of the invention. FIG. 1A shows terminal equipment 100 and an accessory 102, which can be connected to the terminal equipment 100. The terminal equipment 100 comprises a communication interface 104, which enables the connection of external accessories to the terminal equipment. The interface 104 may be realized in different ways, for example Bluetooth, Infrared or other wireless or wireline parallel or serial connection. The interface may support several connection methods. The terminal equipment further comprises a memory 106, which may be used for storing data and applications, and a smart accessory manager 108, which may be implemented in the software of the terminal equipment. The terminal equipment further comprises a software platform 110, such as a java virtual machine, implemented in the software of the terminal equipment as well. The software platform, in this example a java virtual machine, provides an application program interface (API) 112 with different features of the terminal equipment. These features may vary depending on the capabilities of the terminal equipment. These features may comprise a user interface or communication or processing capabilities of the terminal equipment. They are implemented as functions in the API. An application using an API function call may thus utilize a corresponding feature of the equipment defined in the function call.

The smart accessory manager 108 manages accessories connected to the terminal equipment. For example, the manager may automatically detect an accessory connected to the terminal equipment. The manager may also control communication between the terminal equipment and an accessory. The smart accessory manager comprises an accessory protocol defining a bi-directional communication protocol between the terminal equipment and a connected accessory device.

The accessory comprises a communication interface 114, which enables the connection of the accessory 102 to the terminal equipment 100. The interface 114 may be realized in different ways, for example Bluetooth, Infrared or other wireless or wireline parallel or serial connection. The interface may also support several different connection methods. The accessory further comprises a platform 116 to store and execute applications. The platform may be implemented with a processor and memory, for example. The platform comprises information 118 of the applications supported by the accessory. In this example the accessory comprises a proxy application 120 and messaging and browsing applications 122, 124. The accessory supports the accessory protocol of the smart accessory manager 108.

In step 200, the accessory 102 is connected to the terminal equipment 100. In step 202 the connecting of the accessory to the terminal equipment is detected automatically and the smart accessory manager is activated. The communication between the accessory and the terminal equipment may be based on a predefined accessory protocol. According to the protocol, the accessory sends in step 202 a predefined message 126 to the terminal equipment when it is connected to the terminal equipment. The message comprises information that the accessory is a smart accessory and capable of communicating with the terminal equipment. The terminal equipment receives the message, detects that the accessory is a smart accessory and activates the smart accessory manager.

In step 204 the smart accessory manager scans 128 the accessory and obtains information about the accessory, especially the software stored in the accessory. The smart accessory manager detects a proxy application 120 in the accessory. In this example also the messaging application 122 and the browsing application 124 are found. However, these applications are recognised as accessory software applications not to be loaded into the terminal equipment. The proxy application 120 is recognised as a special communication application, which is loaded 130 via the smart accessory manager into the memory 106 of the terminal equipment 100.

In step 206 the proxy application 132 is automatically started 134 and executed as a background application in the java virtual machine 110.

The proxy application sets up and controls 208 data transfer between the accessory and the terminal equipment. The proxy application detects the properties of the connection (connection type, bit rate etc) and controls the communication accordingly. Also, if the connection is a wireless connection in which case there may be interference present during communication, the proxy application may take care of possible retransmissions and/or error correction.

In step 210 the proxy application 132 queries the properties of the application interface 112. The properties of the application interface 112 comprise information about the functions supported by the interface and the version of the interface. The functions supported by the interface indicate the resources or services of the terminal equipment that are available for the accessory applications. These resources or services may include input/output functions or communication features of the terminal equipment, for example. The proxy application sends 138 the information to the accessory applications in step 212.

The accessory software applications 122, 124 thus obtain information about the services provided by the functions available to them. In step 214 the proxy application provides 140 the accessory 122, 124 with the services offered by the application interface 112. The accessory software applications may send function calls to the proxy application, which delivers them to the application program interface 112, which in turn sends results of the function calls back to the accessory software applications via the proxy application 132.

In an embodiment the proxy application may be downloaded from the accessory each time when a connection is established between the terminal equipment and the accessory. In an alternative solution, the proxy application may be downloaded once, executed and then run in the background, and stored in a memory and activated when the accessory is reconnected next time. It may also be installed in the terminal equipment in the production phase.

When a proxy application is stored in the terminal equipment memory and a respective accessory is connected to the terminal equipment, a smart accessory manager may check the version of the proxy application in the accessory and download the proxy application from the accessory if the version in the accessory is newer than the version in the memory.

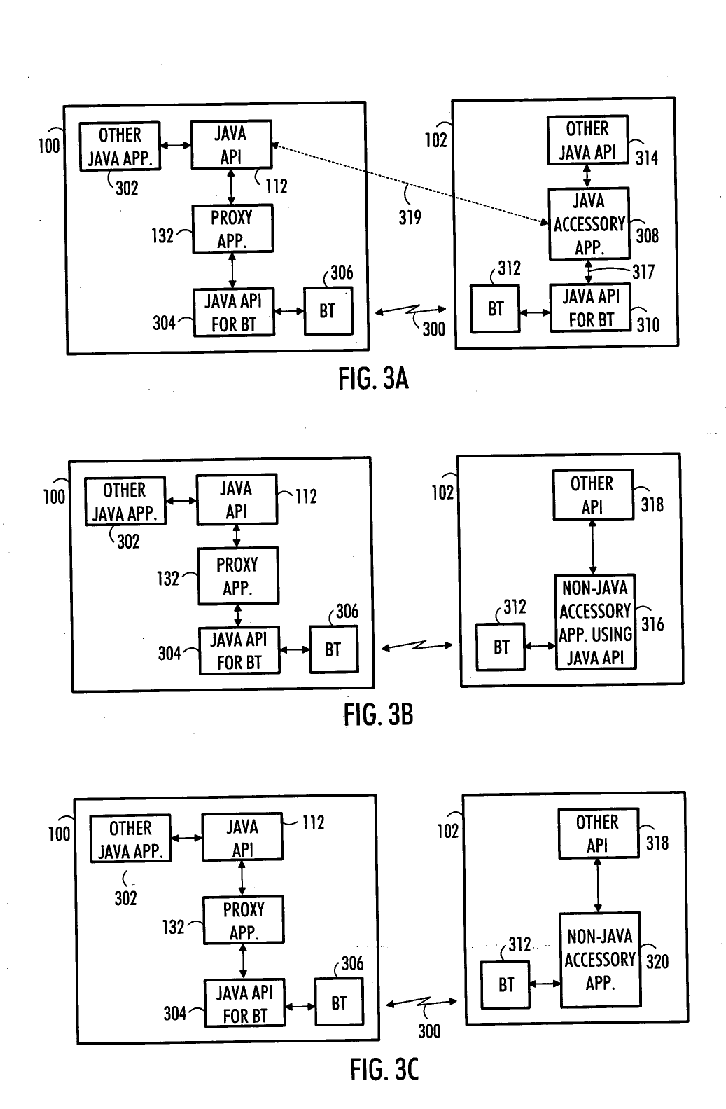

FIG. 3A illustrates an embodiment of the invention. FIG. 3A shows the terminal equipment 100 and an accessory 102 connected to the terminal equipment via a Bluetooth connection 300. The actual realisation of the connection is not relevant and the use of Bluetooth is merely an example.

In the example of FIG. 3A both the terminal equipment 100 and the accessory comprise a java virtual machine. The proxy java application 132 is interpreted by the terminal equipment java virtual machine. The proxy application is executed as a background application. When running of multiple concurrent java applications in the terminal equipment is supported, it is possible that other java applications 302 may be executed simultaneously in the terminal equipment. The other applications may also use API 112 for their own purposes, such as for the use of a display and a keyboard. Such applications can be for example downloaded java games.

The terminal equipment 100 comprises a java API for Bluetooth 304, which handles the physical Bluetooth interface 306. The proxy application sets up and controls data transfer between the accessory and the terminal equipment.

The accessory java virtual machine executes an accessory software application 308. The accessory comprises java API for Bluetooth 310, which handles the physical Bluetooth interface 312 of the accessory. The accessory may also comprise other java APIs 314 which provide an interface to accessory's own resources, which may comprise a display and different input/output devices, for example. The accessory software application 308 may use the APIs 310 and 314. The proxy application acts as an intelligent proxy and shares the java application program interface 112 of the terminal equipment for the accessory software application 308. Thus, for the accessory software application, there is no difference between the use of the accessory's own API 314 and the terminal equipment's API 112. The accessory software application sees the connections 317 and 319 as similar interfaces and does not know that the API 112 is not in the accessory. When running of multiple concurrent java applications in the accessory is supported, other java applications 302 may also be executed simultaneously in the accessory. The other applications may also use API 314 for their own purposes

FIG. 3B illustrates an embodiment of the invention. FIG. 3B shows the terminal equipment 100 and an accessory 102 connected to the terminal equipment via a Bluetooth connection 300. The actual realisation of the connection is not relevant and the use of Bluetooth is merely an example.

In the example of FIG. 3B the terminal equipment 100 comprises a java virtual machine. The proxy java application 132 is interpreted by the terminal equipment java virtual machine. The proxy application is executed as a background application. It is also possible that other java applications 302 may be executed simultaneously in the terminal equipment. The other applications may also use API 112 for their own purposes.

The terminal equipment 100 comprises a java API for Bluetooth 304, which handles the physical Bluetooth interface 306.

The accessory executes a non-java accessory software application 316. The accessory comprises a physical Bluetooth interface 312 communicating with the accessory software application 316. The accessory may also comprise other APIs 318 which provide an interface for accessory's own resources, which may comprise a display and different input/output devices, for example. The accessory software application 316 is configured to use the non-java API 318 with its own proprietary function calls. The proxy application 132 acts as an intelligent proxy and shares the java application program interface 112 of the terminal equipment for the accessory software application 316. The accessory software application 316 is configured to use the java API 112 of the terminal equipment via the Bluetooth connection. Thus, the accessory software application is configured to use java function calls with the terminal equipment's API 112 and non-java function calls with the accessory's own API 318.

FIG. 3C illustrates an embodiment of the invention. FIG. 3C shows the terminal equipment 100 and an accessory 102 connected to the terminal equipment via a Bluetooth connection 300. The actual realisation of the connection is not relevant and the use of Bluetooth is merely an example.

In the example of FIG. 3C the terminal equipment 100 comprises a java virtual machine. The proxy java application 132 is interpreted by the terminal equipment java virtual machine. The proxy application is executed as a background application. As before, other java applications 302 may also be executed simultaneously in the terminal equipment.

The terminal equipment 100 comprises a java API for Bluetooth 304, which handles the physical Bluetooth interface 306.

The accessory executes a non-java accessory software application 320. The accessory comprises a physical Bluetooth interface 312 communicating with the accessory software application 320. The accessory may also comprise other APIs 318, which provide an interface for accessory's own resources. The accessory software application 320 is configured to use the API 318 with its own proprietary function calls. In this embodiment, the accessory software application 320 does not support the use of java function calls at all. In the terminal equipment, the proxy application 132 acts as an intelligent proxy and a parser. The proxy application uses java API function calls in the direction of the API 112, but provides a higher level non-java interface, such as a C, C++, for the application 320 executed in the accessory. The proxy application 132 uses the Bluetooth API 304 for opening a Bluetooth channel for routing the non-java function calls between the proxy 132 and the application 320 located in the accessory.

The non-java accessory software application 320 uses higher layer non java function calls/libraries provided by the proxy java application located in the terminal equipment. These function calls are executed over the Bluetooth connection. The function of the proxy application 132 in this embodiment is to act as a java application for the java API direction and non-java API for the accessory direction.

In an embodiment the proxy application 132 executes several java API function calls from one higher layer function call. For example, the function provided by the 132 proxy in the accessory direction could be of the form send_a_message(parameters). In the java API direction several lower level function calls have to be made to make this action possible.

With this kind of proxy function, the application 320 in the accessory 102 does not have to support the use of the low level java API interface 112, but a simple function interface may be used. This simplifies the application development work of the accessory. Also, the number of messages sent via the Bluetooth connection may be reduced.

Even though the invention is described above with reference to an example according to the accompanying drawings, it is clear that the invention is not restricted thereto but it can be modified in several ways within the scope of the appended claims.

1. A method of communication between terminal equipment and an accessory connected to the terminal equipment, the method comprising
providing in the terminal equipment an application interface for services offered by the terminal,
executing an accessory software application in the accessory,
executing a proxy application in the terminal equipment, the proxy application providing the accessory software application with the services offered by the application interface.

2. The method of claim 1, further comprising
detecting the connecting of the accessory to the terminal equipment automatically in the terminal equipment.

3. The method of claim 2, further comprising
downloading the proxy application from the accessory to the terminal equipment automatically after detecting the accessory.

4. The method of claim 3, further comprising
executing the proxy application in the terminal equipment automatically after downloading.

5. The method of claim 1, wherein the proxy application sets up and controls data transfer between the accessory and the terminal equipment.

6. The method of claim 1, further comprising
querying the properties of the application interface,
sending information about the properties to the accessory software application.

7. The method of claim 6, wherein the properties of the application interface comprise the functions supported by the interface and the version of the interface.

8. The method of claim 1, wherein more than one accessory software application is executed in the accessory.

9. The method of claim 1, wherein the proxy application is a java application and the proxy application is interpreted in the terminal equipment by a java virtual machine.

10. The method of claim 1, wherein the accessory software application is a java application and the application is interpreted in the accessory by a java virtual machine.

11. The method of claim 1, wherein the accessory software application uses the application interface of the terminal equipment via the proxy application.

12. The method of claim 1, further comprising
executing the accessory software application in the accessory as a non-java application,
providing by the proxy application in the terminal equipment a java application interface for the accessory software application.

13. The method of claim 1, further comprising
executing the accessory software application in the accessory as a non-java application,
providing by the proxy application in the terminal equipment a nonjava application interface for the accessory software application.

14. The method of claim 1, wherein the services offered by the terminal comprise communication services and user interface services.

15. The method of claim 1, wherein the accessory software application enables a user of the accessory to operate the terminal equipment.

16. The method of claim 1, wherein the software platform is a Symbian operating system and the proxy application is realized as a Symbian application.

17. Terminal equipment comprising:
a connection interface enabling an accessory to be connected to the terminal equipment,
an application interface to services offered by the terminal,
a software platform configured to execute a proxy application providing services offered by the application interface for an accessory software application executed in an accessory connected to the terminal equipment.

18. The terminal equipment of claim 17, further comprising
an accessory manager configured to download a proxy application from an accessory connected to the terminal equipment.

19. The terminal equipment of claim 17, further comprising
an accessory manager configured to obtain information about accessory software in an accessory connected to the terminal equipment.

20. The terminal equipment of claim 17, the terminal equipment being configured to detect the connecting of the accessory to the terminal equipment automatically.

21. The terminal equipment of claim 17, wherein the software platform is configured to execute a proxy application providing in the terminal equipment a java application interface for the accessory software application executed in an accessory connected to the terminal equipment.

22. The terminal equipment of claim 17, wherein the software platform is configured to execute a proxy application providing in the terminal equipment a non-java application interface for the accessory software application executed in an accessory connected to the terminal equipment.

23. The terminal equipment of claim 17, wherein the software platform is configured to execute a proxy application providing a user interface of an accessory connected to the terminal equipment.

24. The terminal equipment of claim 17, wherein the software platform is a java virtual machine.

25. The terminal equipment of claim 17, wherein the software platform is a Symbian operating system.

26. An accessory for terminal equipment, comprising
means for connecting the accessory to the terminal equipment,
means for executing an accessory software application, configured to communicate with the terminal equipment via a proxy application executed in the terminal equipment and to utilize services offered by the terminal equipment via the proxy application.

27. The accessory of claim 26, further comprising
means for uploading a proxy application to the terminal equipment automatically when being connected to said terminal equipment.

28. The accessory of claim 26, wherein the accessory is a cover for the terminal equipment.

29. The accessory of claim 26, wherein the accessory is an independently functioning external device.

30. The accessory of claim 26, wherein the accessory has a wireless connection to the terminal equipment.

31. The accessory of claim 26, wherein the accessory has a wire line connection to the terminal equipment.

32. The accessory of claim 26, wherein the user interface of the accessory is provided by an application interface of the terminal equipment.

33. The accessory of claim 26, wherein the user interface of the terminal equipment is provided by the accessory.
